(19) United States
(12) Patent Application Publication
(10) Pub. No.: US 2002/0190599 A1
(43) Pub. Date: Dec. 19, 2002

(54) Lateral pressure mechanism for a motor

(76) Inventor: Makoto Akabane, Nagano (JP)

Correspondence Address: HOGAN & HARTSON L.L.P., 500 S. GRAND AVENUE, SUITE 1900, LOS ANGELES, CA, 90071-2611, US

(21) Appl. No.: 10/165,425

(22) Filed: Jun. 6, 2002

(30) Foreign Application Priority Data
Jun. 13, 2001 (JP) 2001-178814

(51) Int. Cl. H02K 1/00; H01R 39/08

(52) U.S. Cl. 310/232

(57) ABSTRACT

A lateral pressure mechanism for a motor includes a rotor shaft rotatively supported by a bearing. A frame surrounds the bearing and the frame has an inner side. A slip ring is disposed on the inner side of the frame and positioned around the rotor shaft. The slip ring includes slide portions against which an outer circumferential surface of the rotor shaft abuts and an engaging portion to prevent the slip ring from rotating. A wire spring is provided around one end of the slip ring wherein a center portion of the wire spring elastically abuts against an outer circumferential surface of the slip ring. The slide portions are formed at symmetric positions with respect to the center portion of the wire spring.

### BACKGROUND OF THE INVENTION

1. Field of the Invention

The present invention relates to a lateral pressure mechanism. More particularly, the present invention relates to a lateral pressure mechanism for a motor used to rotate recording discs such as (compact discs) CDs and (digital versatile discs) DVDs with a high speed of rotation.

2. Related Art

Improvements in the recording density of recording discs have required greater mechanical accuracy in disc rotation. For example, a motor used as a disc rotating motor is manufactured such that a turntable for supporting disc is formed integral with the rotor. An oil-impregnated sintered alloy that does not need additional lubrication and able to rotate at a high-speed, is frequently used as a bearing for the rotor shaft of the motor.

For the oil-impregnated sintered bearing that supports the rotor shaft with a smooth high-speed rotation, it is necessary to have a clearance in which an oil film is formed at least between the sliding surfaces of the bearing and the rotor shaft. The sliding surfaces are defined as an inner circumferential surface of the bearing and an outer circumferential surface of the rotor shaft. However, the rattling of the rotor shaft caused by the clearance makes the turntable vibrate, which may result in reading errors. The reading errors may result because the focusing and/or tracking by an optical pickup device on the signal recording surface of the disc, or the tracking by a magnetic head device on the disc cannot be followed. This causes the device to not performed properly.

As shown in FIG. 6, a lateral pressure mechanism that presses an outer circumferential surface 52 of the rotor shaft 50 against an inner surface 51 of the bearing is used to restrain the vibration of the rotor shaft 50 by applying a lateral pressure F (in the arrow direction) to the rotor shaft 50 in a direction perpendicular to the shaft line L. For this purpose, a slip ring 54 is loosely fitted around the rotor shaft 50 within the inside of a fixed frame 53 that holds the bearing 60. The slip ring 54 is supported by a radial movement of the rotor shaft 50.

A wire spring 57 is suspended in a tensioned state by stud pins 55 and 56 that are provided on the fixed frame 53 at locations opposite from each other. The middle part 57a of the wire spring 57 abuts against an outer circumferential surface 54a of the slip ring 54 and is elastically deformed so as to give an urging force in a direction shown by arrow F. The wire spring 57 is wound around the stud pin 55 at one end portion 58 and abuts against an outer periphery surface 54a of the slip ring 54. The wire spring 57 is engaged with the other stud pin 56 by its free end 59 so as to maintain its elastic deformation. The wire spring 57 is prevented from disengagement by each of the protrusions 61, 62, and 63.

The lateral pressure mechanism described above prevents the rattling of the rotor shaft 50 within the clearance between the rotor shaft 50 and the bearing 60. The rattling of the rotor shaft 50, however, may be due to an imbalance caused by non-uniformity in the thickness of the disc, a label printed on the disc, or a magnetic imbalance. The lateral pressure F, however, is only effective in one direction because the rotor shaft 50 can still move in the direction T which is perpendicular to the direction of the lateral pressure F. Therefore, restraining the rotor shaft 50 from ratting in the direction T is minimal, since the rotor shaft 30 is vertically oriented with the lateral pressure F of the lateral pressure mechanism. Accordingly, vibrations can not be prevented in a device such as an optical pickup device where the rotor shaft moves in a direction T that is perpendicular to the lateral pressure direction F.

It is an advantage of the present invention to provide a lateral pressure mechanism for a motor that can provide a sufficient lateral pressure with a compact structure to prevent the rattling of the rotor shaft.

### SUMMARY OF THE INVENTION

In order to achieve the above advantage, a lateral pressure mechanism for a motor include; a rotor shaft rotatively supported by a bearing. A frame surrounds the bearing and the frame has an inner side. A slip ring is disposed on the inner side of the frame and positioned around the rotor shaft. The slip ring includes slide portions against which an outer circumferential surface of the rotor shaft abuts and an engaging portion to prevent the slip ring from rotating. A wire spring is provided around one end of the slip ring wherein a center portion of the wire spring elastically abuts against an outer circumferential surface of the slip ring. The slide portions are formed at symmetric positions with respect to the center portion of the wire spring.

The slide portions may be formed at two locations of intervals of 90 degrees with respect to the center of the rotor shaft. The engaging portion formed on the slip ring is preferably formed on an opposite side with respect to the center of the rotor shaft from the position at which the wire spring abuts.

### BRIEF DESCRIPTION OF DRAWINGS

FIG. 1 is a sectional side-view of a lateral pressure mechanism for a motor that is an embodiment of the present invention.

FIG. 2 is a plan view of the lateral pressure mechanism along the line II-II in FIG. 1.

FIG. 3 is an enlarged plan view showing a slip ring of the lateral pressure mechanism for the motor in accordance with a first embodiment of the present invention.

FIG. 4 is an enlarged plan view showing a slip ring of the lateral pressure mechanism for the motor in accordance with a second embodiment of the present invention.

FIG. 5 is an enlarged plan view showing a slip ring of the lateral pressure mechanism for the motor in accordance with a third embodiment of the present invention.

FIG. 6 is an enlarged plan view generally showing a slip ring of the lateral pressure mechanism for the motor of the prior art.

### DETAILED DESCRIPTION OF THE PREFERRED EMBODIMENTS

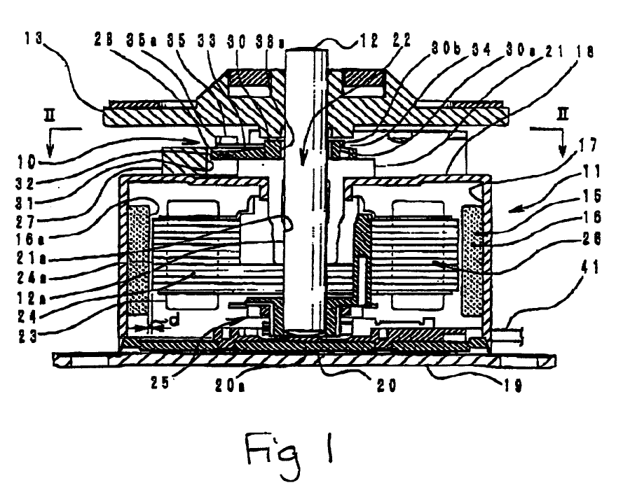

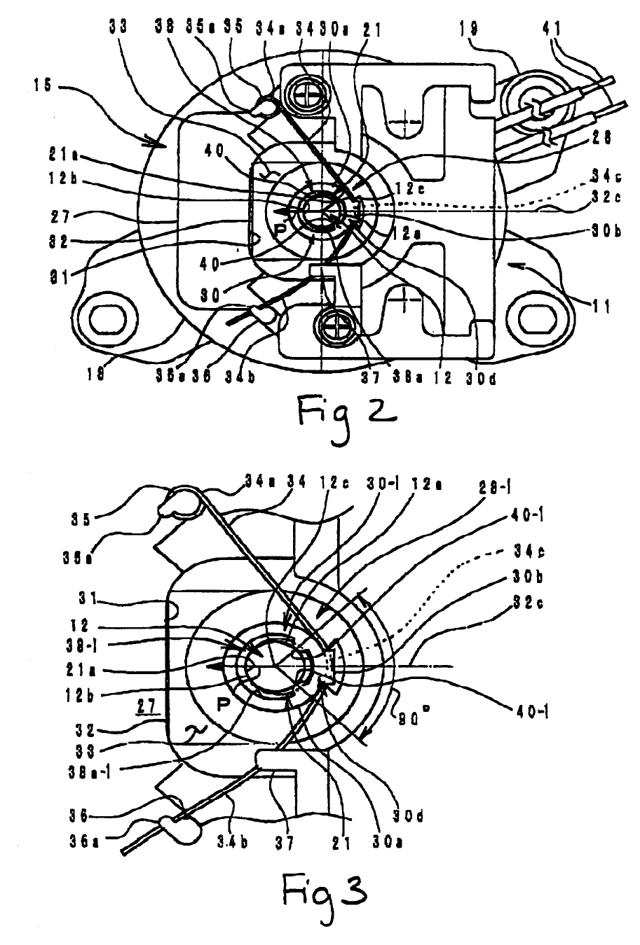

Hereinafter, lateral pressure mechanisms for a motor according to embodiments of the present invention will be described with reference to the accompanying drawings. FIG. 1 is a sectional view showing a lateral pressure mechanism 10 for a motor according to one embodiment of the present invention. The lateral pressure mechanism 10 is applied to a spindle motor 11. The spindle motor 11 is a drive source that includes a rotor shaft 12 and a turntable 13 fixed directly to the rotor shaft 12. The turntable 13 carries a recording medium such as a CD, a DVD, or a magneto-optical disc (not shown). FIG. 2 is a plan view showing the lateral pressure mechanism 10 viewed from the line II-II in FIG. 1.

The spindle motor 11 as a driving source is equipped with a stator member 15 that includes a cylindrical yoke 18 that holds a ring magnet 16 on an inner wall 17 thereof and a base plate 20 that is fitted to the cylindrical yoke 18 so as to shut the inside of the motor and is fixed to A mounting plate 19. An oil-impregnated sintered bearing 21 is fixed at a center position of the cylindrical yoke 18. The rotor shaft 12 inserted into a through-hole 22 provided at the center of the bearing 21 is rotatably supported by its outer circumferential surface 12a of the rotor shaft 12 contacting with an inner surface 21a of the through-hole 21. A small gap is provided, that is necessary to form at least an nil film, between the inner surface 21 a in the through-hole 21 and the outer circumferential surface 12a of the rotor shaft 12 such that frictional resistance between them are reduced as much as possible to assure a free rotation. A thrust load of the rotor shaft 12 is supported by a thrust bearing member 20a and the bottom end of the bearing 21 prevents upward movement of the shaft 12.

The rotor member 26 includes the rotor shaft 12 that is concentrically fixed with an armature core 24 that is wound by coils 23 therearound, and with a commutator unit 25. The rotor member 26 is arranged inside of the cylindrical yoke 18. An outer circumferential surface 24a of the armature core 24 uniformly keeps a predetermined gap “d” with an inner circumferential surface 16a of the ring magnet 16 and the rotor member 26 rotates within the cylindrical yoke 18. The turntable 13 is concentrically fixed to the rotor shaft 12 to thereby rotate with the rotor member 26 together. Reference number 41 is a power source cord for the motor 11.

The rotor member 26 also includes a frame 27 surrounding the bearing 21 which is installed on the cylindrical yoke 18, that is one part of the stator member 15 along with the bearing 21, under the turntable 13. A slip ring 28 is disposed on the inner side of the frame 27 and the rotor shaft 12 is loosely inserted therethrough. As shown in FIG. 2, the slip ring 28 includes a ring body 30 provided with a center hole 38 in the center portion thereof through which the rotor shaft 12 penetrates. The slip ring 28 also includes a base portion 33 provided with a straight part 32 that engages with an inner surface 31 of the frame 27 so as to prevent the slip ring 28 from moving circumferentially.

The straight part 32 of the base portion 33 is positioned on an opposite side of the position where a wire spring 34 abuts against the slip ring 28 with respect to the rotor shaft center 12c. The frame 27 is formed in a U-shape having the inner surface 31 formed flush on its closed side and an opening on its other side. The straight part 32 of the base portion 33 is supported by the inner surface 31 such that the slip ring 28 does not rotate along with the rotation of the rotor shaft 12. Therefore, the direction of the pressure that the wire spring 34 gives a lateral pressure to the rotor shaft 12 via the slip ring 28 is determined. The slip ring 28 is manufactured in such a manner that the ring body 30 is formed from a sintered oil-impregnated alloy integrated with the bare portion 33 made of synthetic resin by performing an insert molding. Alternatively, the slip ring 28 is structured such that both the ring body 30 and the base portion 33 are foamed integrally with a synthetic resin.

As illustrated in FIG. 2, the ring body 30 of the slip ring 28 is cylindrical and a rectangular protrusion 30b is protruded outwardly in a radial direction on the upper edge portion of an outer circumferential surface 30a. Therefore, the wire spring 34 positioned under the protrusion 30b along the outer circumferential surface 30a of the ring body 30 is prevented from disengaging from the ring body 30. The wire spring 34 is suspended in a tensioned state by the two stud pins 35 and 36 that are mounted on both sides of the frame 27 and are positioned in an approximately equal distance from the center-line 32c. One end portion 34a of the wire spring 34 is wound around the stud pin 35 and the free end portion 34b is engaged with the other stud pin 36. The central part 34c of the wire spring 34 presses a cylindrical ring body 30 in a perpendicular direction (the direction of an arrow P) to the straight-shaped inner surface 31 of the frame 27.

The upper end of each of the stud pins 35 and 36 is provided with a laterally protruding section 35a or 36a so as to prevent the wire spring 34 from disengaging from the stud. In addition, a restraint plate 37 is equipped on the side of the free end portion 34b and the wire spring 34 is positioned under the restraint plate 37. Thus the wire spring 34 is prevented from turning over by the restraint plate 37 even though the wire spring 34 has an internal stress due to its elastic deformation and thus the direction of the urging force is regulated.

As shown in greater detail in FIG. 2 through FIG. 5, an inside diameter in the center hole 38 penetrated through the ring body 30 is formed a little larger than the outside diameter of the rotor shaft 12. Two slide portions 40 that are inwardly protruding on an internal circumference surface 38a and are apart from each other in a plane perpendicular to the rotor shaft 12 abut against the periphery surface 12a of the rotor shaft 12. In other words, the slip ring 28 forced by the wire spring 34 presses the outer surface 12a of the rotor shaft 12, which penetrates through the center hole 38, via the two slide portions 40 provided on the internal circumference surface 38a to thereby urge the rotor shaft 12 in the direction of the arrow “P”.

The two slide portions 40 are formed on a plane that is perpendicular to the center line 12c of the rotor shaft 12, at symmetrical locations on either side of the center line 32c that is perpendicular to the straight-shaped inner surface 31 of the frame 27 and that passes through the central line 12c, on the side of the pressure applied portion 30d by the wire spring 34 in relation to the center line 12c of the rotor shaft 12, and apart from each other at about 90 degrees along the internal circumference surface 38a of the center hole 38. Therefore, the wire spring 34 acting on the slip ring 28 generates an equal force component at each of the slide portions 40 with respect to the rotor shaft 12 and the intersection of she operating directions of the two force components determines one point of the inside surface 21a of the bearing 21 to thereby enable the rotor shaft 12 to rotate in a stable condition. As described above, the slip ring 28 gives a direction of force that presses the rotor shaft 12 and thus the slide portions 40 are set such that the direction of the resultant force formed by the force components coincide with the direction that is perpendicular to the straight-shaped inner surface 31 of the frame 27.

As examples of the two slide portions 40, FIG. 3 through FIG. 5 show plan views in which each of the slip rings is shown in a somewhat exaggerated manner respectively, in accordance with a first, second, and third embodiment of the present invention. The same reference numbers are used for the same members and their explanation is not described. FIG. 3 is an enlarged plan view of the first embodiment shown in FIG. 2, in which two arc-shaped protruding portions 40-1 formed as the slide portions 40 of the slip ring 28-1, that are formed united on the inside surface 38-1 in the center hole 38-1 of the ring body 30-1 press the rotor shaft 12 in the two directions owing to the force by the wire spring 34 to thereby press the surface 12b, i.e., the opposite side of the pressure applied portion 30d against one point of the bearing inside surface 21a and support the shaft at three positions.

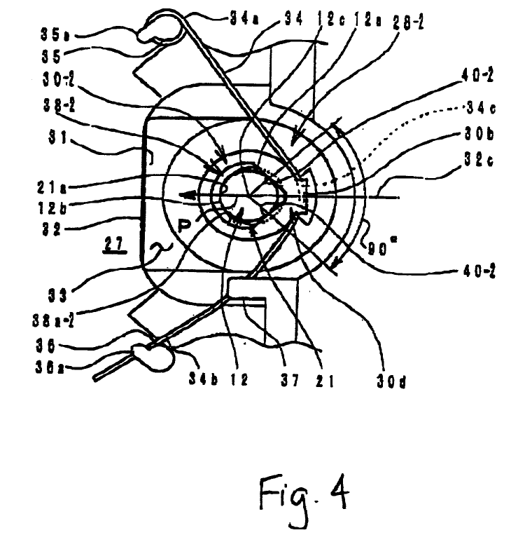

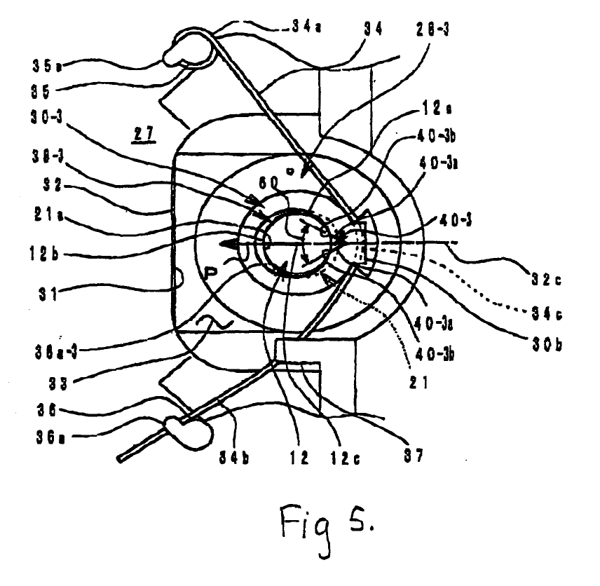

FIG. 4 shows a second embodiment of the present invention. Two flat faces 40-2 as the slide portions arc formed on an inside surface 38a-2 in the center hole 38-2 of the ring body 30-2 of the slip ring 28-2 at an angle of about 90 degrees to press the rotor shaft 12 in the two directions. Accordingly, the opposite side surface 12b of the pressure applied portion 30d is pushed against one point of the bearing inside surface 21a and three position support can be created. Theoretically, the two flat faces 40-2 formed on the inside surface 38a-2 in the center hole of the ring body of the slip ring 28-2 and the bearing inside surface 21a of a larger diameter than the rotor shaft 12 provide line contacts with the cylindrical surface of the outer circumferential surface 12a of the rotor shaft respectively. As a result, the position of the rotor shaft 12 is determined by the three contacting points as in the first embodiment. The slip ring 28-2 in the second embodiment may be preferably manufactured easily by a method of die molding.

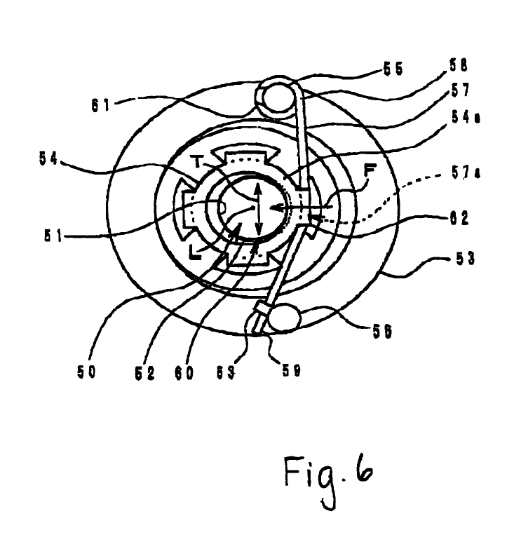

FIG. 5 shows a third embodiment of the present invention. A V-shaped groove 40-3 having an aperture angle of about 60 degrees is cut and formed on an inside surface 38a-3 in the center hole 38-3 of the ring body 30-3 of the slip ring 28-3. In this embodiment, flat faces 40-3a of the V-shaped groove 40-3 intersect with the inside surface 38a-3 of the ring body 30-3 at two locations so as to form edge line portions 40-3b acting as the slide portions, which prows against the outer circumferential surface 12a of the rotor shaft 12 at two locations. And further, the bearing inside surface 21a supports the urged outer circumferential surface 12a of the rotor shaft, and thus the three point support can be attained as in the above embodiment.

According to the third embodiment, the support by the three contacting points is liable to be affected by an external force, but the slide portions are formed extremely easily, for example, by adding a V-shaped groove to a conventional slip ring by machining afterward. The aperture angle of the V-shaped groove 40-3 may be other than about 60 degrees, as long as the two edge line portions 40-3b contact with the rotor shaft 12 from both sides of the central line 32c in a symmetrical relation within a range of not exceeding 180 degrees. In this embodiment in which the sliding portions are formed by the edge line portions 40-3b, the cross-sectional shape of the groove may be a square or a U-shape. In addition, each of the inside surfaces of the ring bodies 30-1, 30-2, 30-3 in accordance with the first, second, and third embodiments is not necessary to be formed as a complete circle, and thus a high precision die is not necessary.

Again, with reference to FIG. 2, the operation of the slip ring 29 is described in the lateral pressure mechanism 10 for a motor according to the present invention. The slip ring 28 that is loosely fitted onto the rotor shaft 12 and that is movable in a radial direction, is elastically pressed in a radial predetermined direction of the rotor shaft 12 by engaging the central part 34c, that is, an elastic deformation part of the wire spring 34. Both ends 34a and 34b of the wire spring 34 are engaged with the stud pins 35 and 36 on the frame 27, and its central part 34c is engaged with the outer circumferential surface 30a of the ring body 30 in a tensioned state. The two sliding portions 40 on the internal circumference surface 38a of the ring body 30 press against the rotor shaft 12. Therefore, the resultant force by the two sliding portions 40 pushes the rotor shaft 12 at one location of the bearing inside surface 21a in a predetermined direction.

In other words, the position of the rotor shaft 12 is retained in a stable state by a three-point support that is cooperatively composed of the two sliding portions 40 and the one inner surface of the bearing. The retained position of the rotor shaft 12 geometrically set is theoretically immovable and thus its vibration is reduced, so long as the rotor shaft 12 is not subjected to an external force greater than the force exerted by the wire spring 34. In addition, the drive current measurements for the motor show that the two sliding portions do not increase friction loss compared to one sliding portion.

As described above, a lateral pressure mechanism of a motor in accordance with the present invention includes two sliding portions that push the rotor shaft to make a pressure contact with the bearing, and thus prevention of rattling or the shaft is improved by the lateral pressure, which results in the reduction of the whirling of the orbit of the rotor shaft. Accordingly, the mechanism can be applied to a spindle motor for a high speed and density recording disc. In addition, since the sliding portions are provided on a plurality of positions, the inside surface of the ring body does not have to be formed as a complete circle and processing accuracy for components including die assembly is not necessary to be strict.

The presently disclosed embodiments are therefore to be considered in all respects as illustrative and not restrictive, the scope of the invention being indicated by the appended claims, rather than the foregoing description, and all changes which come within the meaning and the range of equivalency of the claims are therefore intended to be embraced therein.

While the description above refers to particular embodiments of the lateral pressure mechanism of a motor according to the present invention that are applied to a turntable for recording discs, it will be understood that many modifications may be made without departing from the spirit thereof. On advantage of the present invention is to reduce vibration of a rotor shaft and thus the configuration of the slip ring, the guide frame, or the sliding portions may be modified, and the angle or the positions of de sliding portions, and the load such as a wire spring may also be modified. Further, the present invention may be applicable to a brush motor or a brush-less motor and a motor according to the present invention may be applied to various other applications.

What is claimed is:

1. A lateral pressure mechanism for a motor comprising:
a rotor shaft rotatively supported by a bearing;
a frame surrounding the bearing, the frame having an inner side;
a slip ring disposed on the inner side of the frame and positioned around the rotor shaft, the slip ring including slide portions against which an outer circumferential surface of the rotor shaft abuts and an engaging portion to prevent the slip ring from rotating; and
a wire spring provided around one end of the slip ring wherein a center portion of the wire spring elastically abuts against an outer circumferential surface of the slip ring, the slide portions are formed at symmetric positions with respect to the center portion of the wire spring.

2. The lateral pressure mechanism for a motor according to claim 1, wherein the bearing is an oil-impregnated sintered bearing.

3. The lateral pressure mechanism for a motor according to claim 1, wherein the slip ring includes a ring body provided with a center hole and a base portion.

4. The lateral pressure mechanism our a motor according to claim 3, wherein the rotor shaft protrudes through the center hole.

5. The lateral pressure mechanism for a motor according to claim 3, wherein the base portion is positioned opposite the wire spring.

6. The lateral pressure mechanism for a motor according to claim 3, wherein the base portion engages the inner surface of the frame to prevent the slip ring from moving circumferentially.

7. The lateral pressure mechanism for a motor according to claim 1, wherein the wire spring provides the rotor shaft with pressure in the lateral direction.

8. The lateral pressure mechanism for a motor according to claim 3, wherein the base portion and the ring body are formed integrally using a synthetic resin.

9. The lateral pressure mechanism for a motor according to claim 3, wherein the rectangular protrusion is positioned opposite the base portion, wherein the wire spring is disposed under the rectangular protrusion preventing the wire spring from disengaging from the ring body.

10. The lateral pressure mechanism for a motor according to claim 1, wherein the frame includes stud pins provided on opposite sides of the frame, wherein the wire spring is suspended in a tensioned state by the stud pins.

11. The lateral pressure mechanism for a motor according to claim 1, wherein the slide portions protrude inwardly.

12. The lateral pressure mechanism for a motor according to claim 10, wherein a tensioned state of the wire spring on the slip ring generates an equal force component at each of the slide portions with respect to the rotor shaft.

13. The lateral pressure mechanism for a motor according to claim 1, wherein arc-shaped protruding portions are formed on the slide portions.

14. The lateral pressure mechanism for a motor according to claim 1, wherein the slide portions include flat faces.

15. The lateral pressure mechanism for a motor according to claim 1, wherein the slide portions are formed at locations of 90 degree intervals with respect to the center of the rotor shaft.

16. The lateral pressure mechanism for a motor according to claim 3, further comprising a V-shaped groove having an aperture of 60 degrees formed in an inside surface of the center hole.

17. A lateral pressure mechanism for a motor comprising:
a rotor shaft rotatively supported by a bearing;
a frame surrounding the bearing, the frame having an inner side;
a slip ring disposed on the inner side of the frame and positioned around the rotor shaft, the slip ring including means for abutting the outer circumferential surface of the rotor shaft and an engaging portion to prevent the slip ring from rotating; and
a wire spring provided around one end of the slip ring wherein a center portion of the wire spring elastically abuts against an outer circumferential surface of the slip ring, wherein the means for abutting the rotor shaft are formed at symmetric positions with respect to the center portion of the wire spring.
